(19) United States
(12) Patent Application Publication
(10) Pub. No.: US 2017/0068261 A1
(43) Pub. Date: Mar. 9, 2017

(54) Adaptive Thermal Slope Control

(71) Applicant: MEDIATEK INC., Hsinchu (TW)

(72) Inventors: Jih-Ming Hsu, Taoyuan City (TW); Wei-Ting Wang, Taipei City (TW); Tai-Yu Chen, Taipei City (TW); Wen-Tsan Hsieh, Hsinchu City (TW); Hong-Jie Huang, Tainan City (TW); Pei-Yu Huang, Hsinchu City (TW); Ming-Hsien Lee, Hsinchu City (TW)

(21) Appl. No.: 15/257,022

(22) Filed: Sep. 6, 2016

Related U.S. Application Data
(60) Provisional application No. 62/215,289, filed on Sep. 8, 2015.

(51) Int. Cl. G05D 23/19; G05B 13/04

(52) U.S. Cl. CPC G05D 23/1917; G05B 13/048

(57) ABSTRACT

Methods and apparatus are provided for adaptive thermal slope control for dynamic thermal management. In one novel aspect, the device monitors and obtains sampling temperatures, calculates a thermal-slope index, determines whether the calculated thermal-slope index is greater than a predefined slope threshold, adjusts a power budget based on a thermal-slope algorithm, and applies the dynamic thermal management (DTM) adaptively based on the adjusted power budget. In one embodiment, fixed slope algorithm is used. The power budget is adjusted such that an adjusted slope of temperatures stays at a constant. In another embodiment, the time prediction algorithm is used. The power budget is adjusted such that a predicted time to reach a predefined thermal threshold stays a constant. In one embodiment, the time-prediction algorithm is a time-to-target-point (T2TP) algorithm. The T2TP is obtained using a linear equation or a LOG equation.

### CROSS REFERENCE TO RELATED APPLICATIONS

This application claims priority under 35 U.S.C. §119 from U.S. Provisional Application No. 62/215,289, entitled “ADAPTIVELY THERMAL SLOPE CONTROL,” filed on Sep. 8, 2015, the subject matter of which is incorporated herein by reference.

### TECHNICAL FIELD

The disclosed embodiments relate generally to power/resource budget method, and, more particularly, to precious power/resource budget.

### BACKGROUND

With the rapid growth in mobile/wireless and other electronics devices, the battery life becomes an important factor in the success of such devices. At the same time, many advanced applications for these devices are becoming more and more popular. Such applications normally require high performance of components in the devices. Sustainable power is limited by the dissipation capability and thermal constraint. The device or semiconductor chips can malfunction if the temperature is too high. Thermal throttle methods are commonly used in the devices to prevent overheat problems due to the dissipation limitation. Particularly, owing to limited power budget on handheld devices, the mobile SoC need to meet high performance and high energy efficiency at the same time. The traditional thermal throttling unnecessarily sacrifices the performance in order to maintain the temperature with the target temperature. In the traditional way, the device monitors the temperature and triggers power reduction if the temperature becomes higher than a threshold. If the power reduction is too fast, it results in noticeable performance degradation and affects overall device performance. The performance is limited by the sustainable power. If the power reduction is too slow, the temperature continues to rise before it goes down. Overheating will cause shortened lifespan of the chips or even cause permanent damage to the device.

Recently, dynamic thermal management (DTM) policies/algorithm are developed for control power by thermal throttling. DTM considers the silicon die temperature Tj to control the Operation Point (OPP) of CPU cores, such as the number of operating cores, the operating frequency, and the operating voltage. Other techniques include dynamic voltage and frequency scaling (DVFS) and hot-plug. In the traditional way, DTM will be throttling when the Tj reaches a temperature threshold and will try to keep the Tj below the temperature threshold, named the target Tj, the max Tj or the throttling point (TP).

There are multiple problems with the current DTM. On rapid big power the Tj will overshoot and bounce to higher than the target Tj, resulting in potential damages to the device. On the other hand, to prevent the overshot Tj to reach the maximum allowable Tj, the DTM may need to choose a lower target Tj to reserve some margin to the max Tj. The lowered target Tj results in lower performance.

Improvements and enhancements are needed for DTM for electronic devices.

### SUMMARY

Methods and apparatus are provided for adaptive thermal slope control for dynamic thermal management. In one novel aspect, the device monitors and obtains sampling temperatures, wherein the sampling temperatures include a current temperature and a previous temperature. The device then calculates a thermal-slope index based on the sampling temperatures, wherein the thermal-slope index is slope-related value based on the current temperature and the previous temperature. The device determines whether the calculated thermal-slope index is greater than a predefined slope threshold. The device adjusts a power budget based on a thermal-slope algorithm. The device applies the dynamic thermal management (DTM) adaptively based on the adjusted power budget.

In one embodiment, fixed slope algorithm is used. The power budget is adjusted such that an adjusted slope of temperatures stays at a constant. The temperature slope is calculated based on the current the previous sampling temperatures. In one embodiment, the power budget is adjusted by the difference between the current temperature slope and the slope_limit. The slope_limit can be predefined or preconfigured.

In another embodiment, the time prediction algorithm is used. The power budget is adjusted such that a predicted time to reach a predefined thermal threshold stays a constant. In one embodiment, the time-prediction algorithm is a time-to-target-point (T2TP) algorithm. The thermal-slope index is a T2TP index calculated to indicate a time to reach a target thermal point. In one embodiment, the thermal point is the thermal wall, which can be predefined or preconfigured. In one embodiment, the T2TP is obtained using a linear equation calculation. In another embodiment, the T2TP is obtained using a LOG equation.

In one embodiment, the sampling temperature is selected from a group of measureable temperatures comprising: a junction temperature of a silicon die, an index of PCB temperature (T_pcb), an index of skin temperature (T_skin), and a thermal measure from heat sources including a GPU, a DSP, a multi-media and a communication device. In another embodiment, the power budget is a power index being tracked and allocated for DTM, and wherein the power index comprising: a number of operating cores, an operating frequency, and an operating voltage.

Further details and embodiments and methods are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 shows simplified block diagrams of a device that performs adaptive thermal slope control for DTM in accordance with embodiments of the current invention.

FIG. 2 illustrates an exemplary chart of DTM based on temperature slope control in accordance with embodiments of the current invention.

FIG. 3 shows an exemplary temperature slope function curves using temperature slope control with time prediction in accordance with embodiments of the current invention.

FIG. 4 shows an exemplary flow diagram for DTM using thermal slope control with fixed slope in accordance with embodiments of the current invention.

FIG. 5 shows an exemplary flow diagram for DTM using thermal slope control with time prediction in accordance with embodiments of the current invention.

FIG. 6 shows an exemplary diagram of time-to-throttle point prediction in accordance with embodiments of the current invention.

FIG. 7 shows an exemplary flow chart of the thermal slope control method for the DTM in accordance with embodiments of the current invention.

### DETAILED DESCRIPTION

Reference will now be made in detail to some embodiments of the invention, examples of which are illustrated in the accompanying drawings.

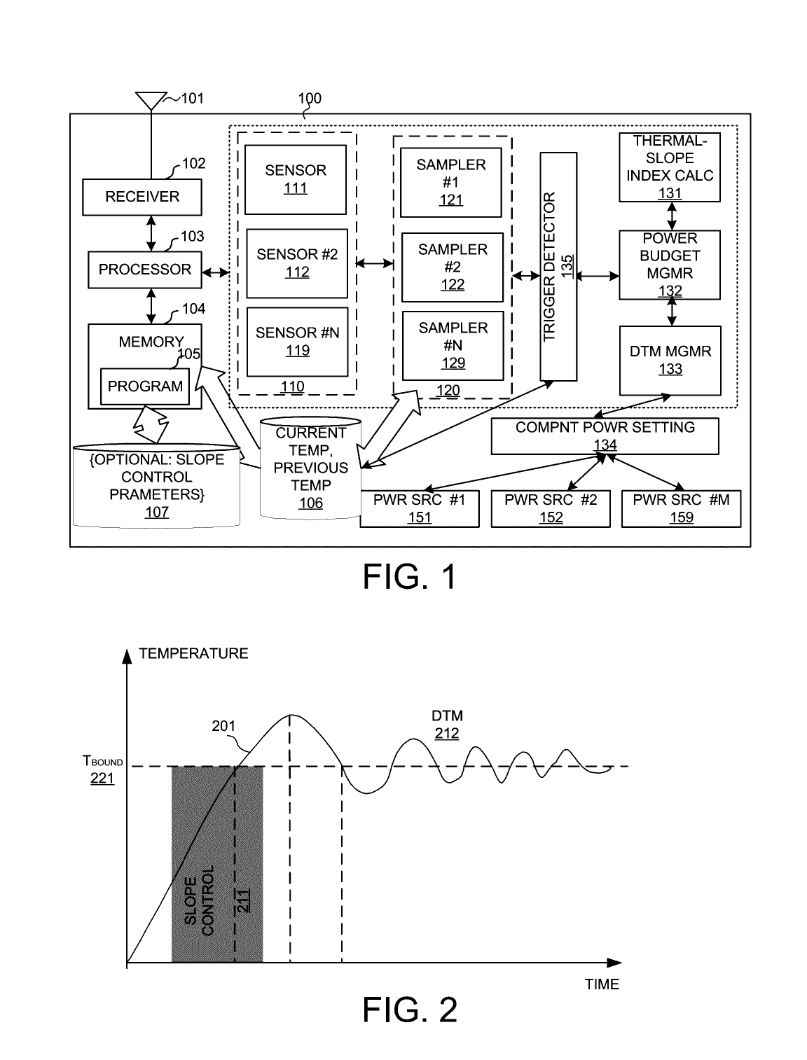

FIG. 1 shows simplified block diagrams of a device that performs adaptive thermal slope control for DTM in accordance with embodiments of the current invention. Device 100 has an optional antenna 101 that receives wireless radio signals. A receiver module 102, optionally coupled with the antenna, receives RF signals from antenna 101, converts them to baseband signals and sends them to processor 103. Processor 103 processes the received baseband signals and invokes different functional modules to perform features in device 100. Memory 104 stores program instructions and data to control the operations of device 100. One or more databases are stored in memory 104. Device 100 includes one or more power sources, such as a power source #1 151, a power source #2 152, and a power source #M 159. In one embodiment, each power source is controlled with corresponding power limit. The power setting of each power source is adjusted based on its corresponding power limit. The power sources may include CPU, GPU, DSP, MCU, and other communication devices.

In one embodiment, one or more database, such as database 106 and database 107 may reside in memory 104, or in a hard disk inside device 100. Further, database 106 and/or database 107 may also reside in other forms of memory external to device 100. Database 106 stores one or more sets of the current temperature and the previous temperature. The temperatures may be one or more temperatures measured as the die temperature Tj, the temperature index T_pcb and/or T_skin, and the temperatures measured at thermal resources, such as the CPU, GPU, DSP, multi-media, and other communication devices. Database 107 stores predefined or preconfigured parameters for thermal slope control, such as the target temperature, the slope limit, the DTM period, the fixed slope threshold, and the time prediction threshold.

Device 100 also includes a set of control modules, such as sensors 110, temperature samplers 120, a thermal-slope index calculator 131, a power budget manager 132, a dynamic thermal management (DTM) manager 133, a component power-setting unit 134, and a trigger detector 135. Sensors 110 includes one or more sensors, such as sensor #1 111, sensor #2 112, and sensor #N 113. In one embodiment, each sensor corresponds to a temperature sampler, such as sampler #1 121, sampler #2 122, and sampler #N 123. In one embodiment, the sensor and the sampler can reside in one module/unit.

In one novel aspect, thermal-slope index calculator 131 calculates a thermal-slope index based on the sampling temperatures, wherein the thermal-slope index is slope-related value based on the current temperature and the previous temperature. In one embodiment, the current temperature and the pervious temperature are Tj. In other embodiments, the current temperature and the pervious temperature can be temperature measured at one or more thermal sources, such as the CPU, GPU, multi-media, and other communication devices. The current temperature and the pervious temperature can also be temperature index, such as the T_pcb or the T_skin. In one embodiment, the thermal-slope index is a temperature slope based on the current and the previous temperature. In one embodiment, the temperature slope is calculated by the differences between the current and the previous temperature divided by a period of time. In one embodiment, the period of time is a DTM period. In another embodiment, the period of time is one tick.

Trigger detector 135 determines whether the calculated thermal-slope index by thermal-slope index calculator 131 is greater than a predefined slope threshold. In one embodiment, the slope threshold is a constant thermal slope. In another embodiment, the slope threshold is a prediction time value.

Power budget manager 132 adjusts a power budget based on a thermal-slope algorithm. In one embodiment, the thermal-slope algorithm is a fixed slope algorithm, and wherein the power budget is adjusted such that an adjusted slope of temperatures stays at a constant, and wherein the thermal-slope index is an index of the sampling temperatures. In another embodiment, the thermal-slope algorithm is a time-prediction algorithm, and wherein the power budget is adjusted such that a predicted time to reach a predefined thermal threshold stays a constant. In yet another embodiment, thermal-slope algorithm is a time-to-target-point (T2TP) algorithm, wherein the thermal-slope index is a T2TP index calculated to indicate a time to reach a target thermal point.

DTM manager 133 applies a DTM adaptively based on the adjusted power budget. Component power-setting unit 134 determines component power settings for each corresponding component based on the power budget and the policies from DTM manager 133. DTM manager 133 considers the power budget to control the Operation Point (OPP) of CPU cores, such as the number of operating cores, the operating frequency, and the operating voltage. Other techniques include dynamic voltage and frequency scaling (DVFS) and hot-plug.

FIG. 2 illustrates an exemplary chart of DTM based on temperature slope control in accordance with embodiments of the current invention. A bound temperature T_{bound} 221 is configured or predefined. T_{bound} 221 is the upper temperature limit to trigger dynamic thermal management control. Curve 201 is the current power setting adjusted based on the temperature in accordance with embodiments of the current invention.

To prevent the thermal overshoot caused by rapid big power, thermal slope control phase 211 is added. During thermal slope control phase, the thermal-slope is calculated. Subsequently, the power budget is adjusted based on the thermal-slope index. The device dynamically sends the thermal-slope feedback to control the temperature. During the DTM phase 212, the DTM procedure adjusts and controls one or more thermal sources based on the power budget set during the thermal-slope control phase 211. Thermal slope control phase 211 operates before and during the DTM phase 212.

In one novel aspect, the thermal slope is adjusted to a fixed slope. The calculated thermal slope index is a slope value during a period of Dt based on a current and a previous temperature sampling values. The adjusted power budget is targeted to keep the thermal slope to a constant value. In one embodiment, the constant value of the thermal slope is predefined or pre-configured. The thermal slope control is triggered is the calculated thermal slope index is greater than a temperature slope threshold. The temperature slope threshold is predefined or preconfigured.

In another novel aspect, the thermal slope is controlled with time prediction. In one embodiment, the time prediction is the predicted time for the temperature to reach a target value. The target value is predefined or preconfigured. The DTM controls the thermal sources such that the temperature reaching a target threshold at a fixed predicted time. The thermal slope control with time prediction has higher performance than the fixed slope thermal slope control.

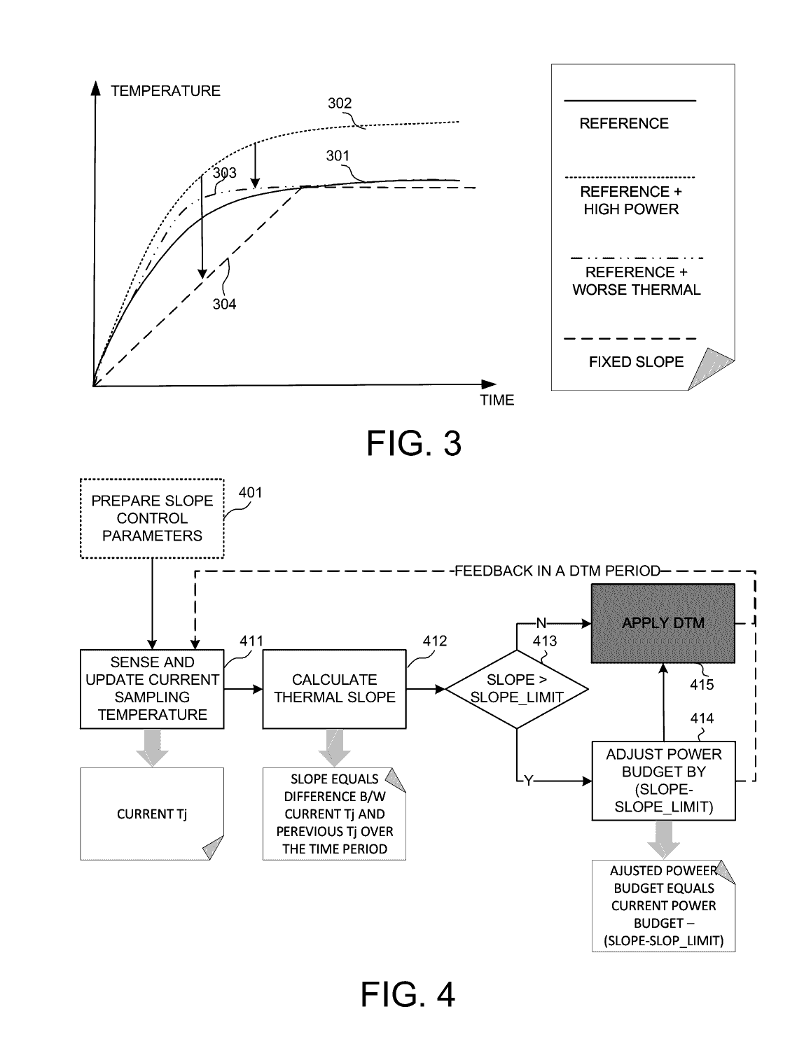

FIG. 3 shows an exemplary temperature slope function curves using temperature slope control with time prediction in accordance with embodiments of the current invention. As an example, the junction temperature Tj is used for the curves 301, 302, 303, and 304. It is understood by an ordinary skills in the art that other temperatures, such the measured temperature at the CPU, DPU, DSP, multi-media, and communication devices, and temperature index, such as the T_pcb or T_skin, can also be used.

A Tj slope curve 301 is the reference curve for the temperature slope control with time prediction The Tj slope value is a mixed function of one or more factors, including the power, the temperature delta, the thermal solution, and thermal coupled from other heat-sources. In particular, the higher the power, the sharper the temperature slope. The temperature delta between Tj and Tj_stable is also a factor—the higher the delta value, the shaper the temperature slope. Further, different thermal solutions also affect the shape of the temperature slope—the less efficient or worse the thermal solution, the sharper the temperature slope. Furthermore, when the measured source is coupled from other heat-sources, the temperature slope curve is different.

FIG. 3 shows a reference curve 302 with a higher power than reference curve 301. The slope is sharper than reference curve 301. The higher power makes the components heat up faster than with lower power operations. Curve 303 shows the temperature slope function with a worse thermal solution than that of reference curve 301. The slope of curve 303 is higher than reference curve 301.

A fixed slope curve 304 is also shown in FIG. 3. The temperature slope as shown in curve 304 is a fixed slope forming a straight line before the reference temperature curve 301 reaches a stable temperature. In one novel aspect, a calculated temperature slope is compared with a fixed slope. If the difference is greater than a threshold, the power budget for the DTM procedure will be adjusted. The adjusted power budget will try to make the slope stay at the constant value as shown in curve 304.

The adaptive thermal slope control prevents temperature overshoot and makes the system more efficient. There are two major algorithm for the thermal slope control. The first is the thermal slope control with fixed slope. The method controls the thermal slope to a constant value. The second is the thermal slope control with time prediction. The following diagrams illustrate the different embodiments.

FIG. 4 shows an exemplary flow diagram for DTM using thermal slope control with fixed slope in accordance with embodiments of the current invention. At step 401, the device optionally configures slope control parameters. The control parameters prepares for the thermal slope control. It can be predefined or configured through network. The slope control parameters can be changed dynamically. The slope control parameter may include one or more parameters including target temperature, the slope limit, the DTM period, the fixed slope threshold, and the time prediction threshold. At step 411, the device senses and updates current sampling temperatures. The current sampling temperatures may be silicon die temperature, also known as the junction temperature Tj. In other embodiments, the sampling temperature can be an index of PCB temperature (T_pcb), an index of skin temperature (T_skin), and a thermal measure from heat sources including a GPU, a DSP, a multi-media and a communication device. In one embodiment, the source sampling temperatures is predefined or can be part of the thermal-slope control parameters configured. In another embodiment, the type of the sampling temperature can be configured through network. As an example, the obtained sampling temperature is Tj with a sampling rate of Dt. In one embodiment, the sampling rate Dt is one tick.

At step 412, the device calculates the temperature slope. The temperature slope is calculated based on a current sampling temperature and a previous sampling temperature. In one embodiment, the temperature slope equals to the difference of the current temperature and the previous temperature divided by the time between the current sampling time and the previous sampling time. The temperature slope is also proportional the different between the stable temperature and the current temperature with an exponential function of the time between the current sampling time and the previous sampling time. Therefore, the higher the power, the higher the stable temperature, it results in the sharper the slope. On the other hand, worse thermal solution, such as bad heat dissipation, also results in sharper slope.

At step 413, the device determines whether the calculated temperature slope is greater than a predefine slope_limit value. The slope_limit can be stored in the memory or a database. In one embodiment, the slope_limit can be obtained during step 401 when preparing for the slope control parameters. In other embodiments, the slope_limit for different type of sampling temperatures may be the same or may be different. If step 413 determines the current calculated temperature slope is greater than the temperature slope threshold, it moves to step 414.

At step 414, the device adjusts the power budget based on the current temperature slope and the temperature slope_limit. In one embodiment, the power budget is adjusted by the difference between the current temperature slope and the slope_limit. Upon updating the power budget, it moves to step 415. Further, if step 413 determines the current calculated temperature slope is not greater than the temperature slope threshold, it also moves to step 415.

At step 415, the device applies DTM based on the adjusted power budget. In one embodiment, different power budget can be generated for different thermal sources. In another embodiment, the same power budget is used for one or more different sources. The type of power budget can be predefined or preconfigured.

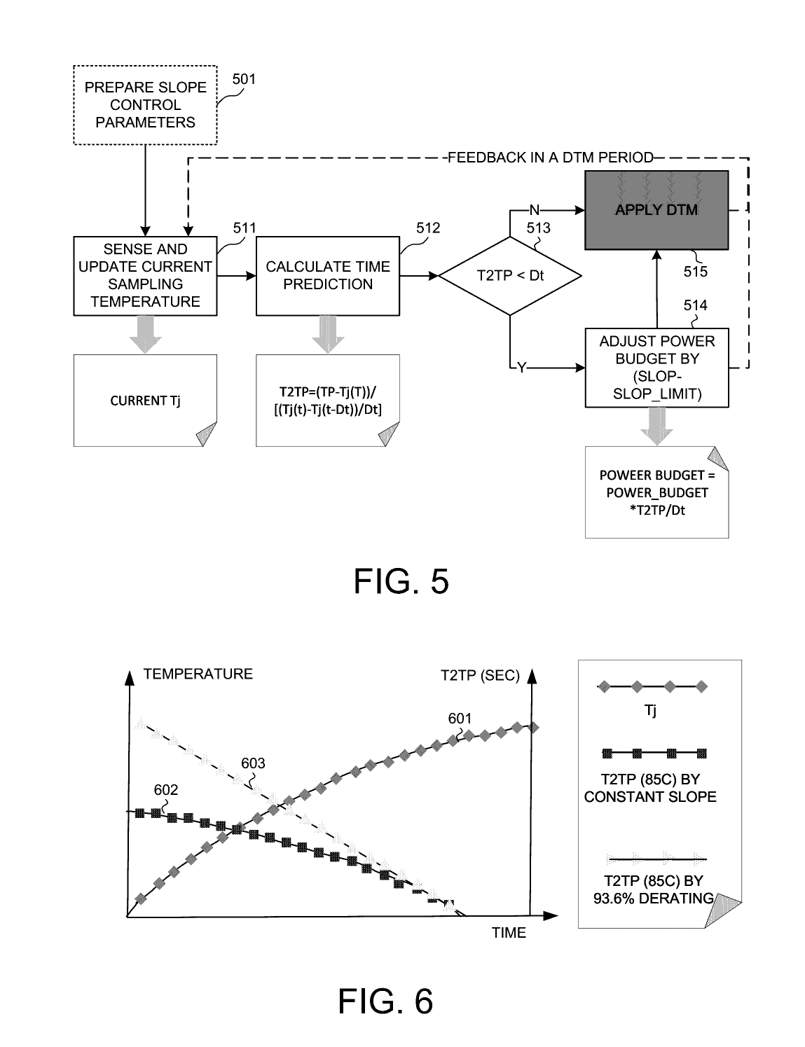

FIG. 5 shows an exemplary flow diagram for DTM using thermal slope control with time prediction in accordance with embodiments of the current invention. At step 501, the device optionally configures slope control parameters. The control parameters prepares for the thermal slope control. It can be predefined or configured through network. The slope control parameters can be changed dynamically. The slope control parameter may include one or more parameters including target temperature, the slope_limit, the DTM period, the fixed slope threshold, and the time prediction threshold.

At step 511, the device senses and updates current sampling temperatures. The current sampling temperatures may be silicon die temperature, also known as the junction temperature Tj. In other embodiments, the sampling temperature can be an index of PCB temperature (T_pcb), an index of skin temperature (T_skin), and a thermal measure from heat sources including a GPU, a DSP, a multi-media and a communication device. In one embodiment, the source sampling temperatures is predefined or can be part of the thermal-slope control parameters configured. In another embodiment, the type of the sampling temperature can be configured through network. As an example, the obtained sampling temperature is Tj with a sampling rate of Dt. In one embodiment, the sampling rate Dt is one tick.

At step 512, the device calculates the time prediction. In one embodiment, the time prediction is a time to the target point (T2TP), which is the predicted time to reach a target point. In one embodiment, the target point is a thermal wall, which is predefined or preconfigured. The value of thermal wall or other target points and/or the threshold value for those target points are predefined or preconfigured. It may be stored in the memory or in a database. It can configured by the network as well. In one embodiment, the T2TP is calculated using a linear equation. The linear equation is based on the value of the target point, the current sampling temperature, the previous sampling temperature, and the time resolution of sampling. In another embodiment, the LOG equation is used to obtain the T2TP.

At step 513, the device determines whether the calculated temperature slope is smaller than a predefine time period Dt. The Dt can be stored in the memory or a database. In one embodiment, the Dt can be obtained during step 401 when preparing for the slope control parameters. In other embodiments, the Dt for different type of sampling temperatures may be the same or may be different. If step 513 determines the current calculated T2TP is smaller than the configured time period of Dt, it moves to step 514.

At step 514, the device adjusts the power budget based on the current T2TP and the current power budget. In one embodiment, the power budget is adjusted by a factor of T2TP over the period Dt. Upon updating the power budget, it moves to step 515. Further, if step 513 determines the current calculated temperature slope is not greater than the temperature slope threshold, it also moves to step 515.

At step 515, the device applies DTM based on the adjusted power budget. In one embodiment, different power budget can be generated for different thermal sources. In another embodiment, the same power budget is used for one or more different sources. The type of power budget can be predefined or preconfigured.

FIG. 6 shows an exemplary diagram of time-to-throttle point prediction in accordance with embodiments of the current invention. A curve 601 shows an exemplary Tj curve against time. As discussed above, different algorithm can be used to obtain T2TP. A linear equation approach uses linear equation to obtain the T2TP. In one embodiment, the T2TP is proportional to the difference between the target point and the current temperature and reversely proportional the difference between the current temperature and the previous temperature divided by the time resolution. A curve 602 shows a T2TP against time at 85C using a constant slope. A LOG equation approach uses LOG functions to get the T2TP more accurately. It is more complicated than the linear equation. In one embodiment, the T2TP is generated with a LOG equation. The parameters to the LOG function are the target point, the current temperature, the previous temperatures, and an index_a. Index_a is proportional to the difference between the current temperature and the previous temperature. Index_a is also reversely proportional to different between the previous temperature and the temperature right before the previous temperature measurement. The index_a can be predefined or preconfigured. A curve 603 shows a T2TP against time at 85 C by the index_a of 93.6% de-rating.

Other algorithms are available to adjust the power budget. In one embodiment, certain conditions are checked first. The conditions are the target point is greater than the current temperature, AND the current temperature is higher than the previous temperature, AND the difference between the target point and the current temperature is smaller than the difference between the current temperature and the previous temperature. If the above condition returns true, the device adjust the power budget. The adjusted power budget is adjusted based on the current power budget by a factor of the difference between the target point and the current temperature over the difference between the current temperature and the previous temperature.

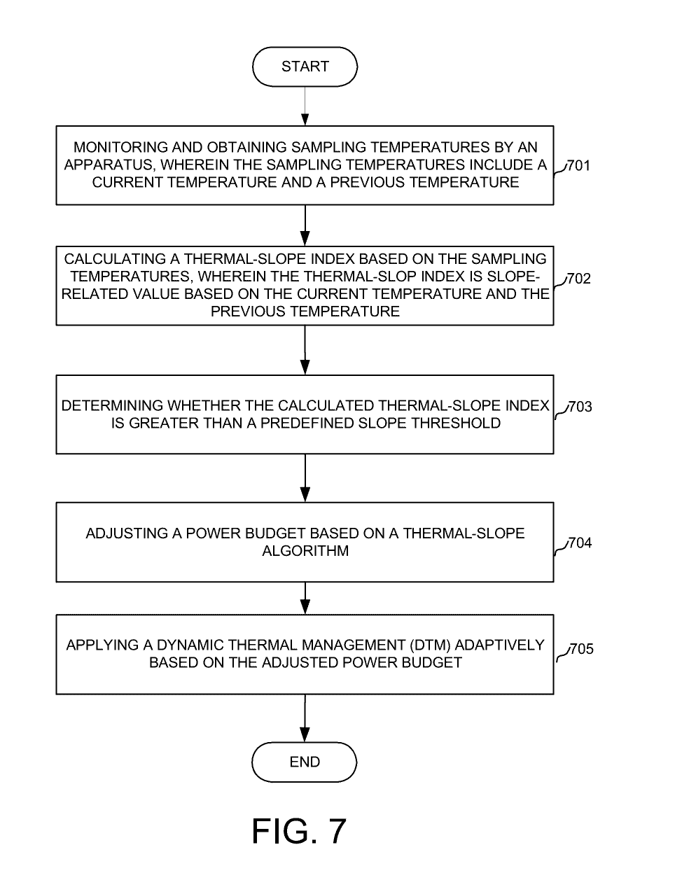

FIG. 7 shows an exemplary flow chart of the thermal slope control method for the DTM in accordance with embodiments of the current invention. At step 701, the device monitors and obtains sampling temperatures by an apparatus, wherein the sampling temperatures include a current temperature and a previous temperature. At step 702, the device calculates a thermal-slope index based on the sampling temperatures, wherein the thermal-slope index is slope-related value based on the current temperature and the previous temperature. At step 703, the device determines whether the calculated thermal-slope index is greater than a predefined slope threshold. At step 704, the device adjusts a power budget based on a thermal-slope algorithm. At step 704, the device applies a dynamic thermal management (DTM) adaptively based on the adjusted power budget.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
monitoring and obtaining sampling temperatures by an apparatus, wherein the sampling temperatures include a current temperature and a previous temperature;
calculating a thermal-slope index based on the sampling temperatures, wherein the thermal-slope index is slope-related value based on the current temperature and the previous temperature;
determining whether the calculated thermal-slope index is greater than a predefined slope threshold; and
adjusting a power budget based on a thermal-slope algorithm; and
applying a dynamic thermal management (DTM) adaptively based on the adjusted power budget.

2. The method of claim 1, wherein the thermal-slope algorithm is a fixed slope algorithm, and wherein the power budget is adjusted such that an adjusted slope of temperatures stays at a constant, and wherein the thermal-slope index is an index of the sampling temperatures.

3. The method of claim 1, wherein adjusting the power budget is based on a slope limit.

4. The method of claim 3, wherein a current power budget is adjusted by the difference between the calculated slope and the slope limit.

5. The method of claim 1, wherein the thermal-slope algorithm is a time-prediction algorithm, and wherein the power budget is adjusted such that a predicted time to reach a predefined thermal threshold stays a constant.

6. The method of claim 5, wherein the time-prediction algorithm is a time-to-target-point (T2TP) algorithm, wherein the thermal-slope index is a T2TP index calculated to indicate a time to reach a target thermal point.

7. The method of claim 6, wherein the target thermal point is a thermal wall.

8. The method of claim 6, wherein a linear equation is used to obtain the T2TP index.

9. The method of claim 6, wherein a LOG equation is used to obtain the T2TP index.

10. The method of claim 1, wherein the sampling temperature is selected from a group of measureable temperatures comprising: a junction temperature of a silicon die, an index of PCB temperature (T_pcb), an index of skin temperature (T_skin), and a thermal measure from heat sources including a GPU, a DSP, a multi-media and a communication device.

11. The method of claim 1, wherein the power budget is a power index being tracked and allocated for DTM, and wherein the power index comprising: a number of operating cores, an operating frequency, and an operating voltage.

12. The method of claim 11, wherein the number of operating cores includes a combination of number of operating CPU, GPU, DSP, MCU, and communication devices.

13. An apparatus, comprising:
one or more temperature sensors that monitors temperatures for one or more corresponding components;
one or more temperature samplers that obtains sampling temperatures, wherein the sampling temperatures include a current temperature and a previous temperature;
a thermal-slope index calculator that calculates a thermal-slope index based on the sampling temperatures, wherein the thermal-slope index is slope-related value based on the current temperature and the previous temperature;
a trigger detector that determines whether the calculated thermal-slope index is greater than a predefined slope threshold; and
a power budget manager that adjusts a power budget based on a thermal-slope algorithm; and
a dynamic thermal management (DTM) manager that applies a DTM adaptively based on the adjusted power budget.

14. The apparatus of claim 13, wherein the thermal-slope algorithm is a fixed slope algorithm, and wherein the power budget is adjusted such that an adjusted slope of temperatures stays at a constant, and wherein the thermal-slope index is an index of the sampling temperatures.

15. The apparatus of claim 13, wherein the thermal-slope algorithm is a time-prediction algorithm, and wherein the power budget is adjusted such that a predicted time to reach a predefined thermal threshold stays a constant.

16. The apparatus of claim 15, wherein the time-prediction algorithm is a time-to-target-point (T2TP) algorithm, wherein the thermal-slope index is a T2TP index calculated to indicate a time to reach a target thermal point.

17. The apparatus of claim 15, wherein the T2TP index is obtained using one prediction equation selecting from an equation group comprising: a LOG equation and a linear equation.

18. The apparatus of claim 13, wherein the sampling temperature is selected from a group of measureable temperatures comprising: a junction temperature of a silicon die, an index of PCB temperature (T_pcb), an index of skin temperature (T_skin), and a thermal measure from heat sources including a GPU, a DSP, a multi-media and a communication device.

19. The apparatus of claim 13, wherein the power budget is a power index being tracked and allocated for DTM, and wherein the power index comprising: a number of operating cores, an operating frequency, and an operating voltage.

20. The apparatus of claim 13, wherein the number of operating cores includes a combination of number of operating CPU, GPU, DSP, MCU, and communication devices.
